(19) United States
(12) Patent Application Publication
(10) Pub. No.: US 2017/0020313 A1
(43) Pub. Date: Jan. 26, 2017

(54) HANDS-FREE HOLDER FOR ELECTRONIC DEVICES

(71) Applicants: Steven Sanh, El Cajon, CA (US); Daniel Sanh, El Cajon, CA (US)

(72) Inventors: Steven Sanh, El Cajon, CA (US); Daniel Sanh, El Cajon, CA (US)

(21) Appl. No.: 15/216,643

(22) Filed: Jul. 21, 2016

Related U.S. Application Data
(60) Provisional application No. 62/195,265, filed on Jul. 21, 2015.

(51) Int. Cl. A47G 9/10; A45F 5/00; F16M 11/40; F16M 13/04; F16M 11/26

(52) U.S. Cl. CPC A47G 9/1045; F16M 13/04; F16M 11/26; F16M 11/40; A45F 5/00

(57) ABSTRACT

A hands-free holder includes a pillow adapted to engage to a user's body. One embodiment comprises of one arm connected to the pillow and terminating at an adjustable device mount, allowing the user to view a tablet, phone, or other screen device without use of the user's hands. Another embodiment comprises of two arms connected to the pillow and terminating at separate adjustable device mounts, one adjustable device mount, or a support which a device mount will attach to allowing the user to view a tablet, phone, or other screen device without use of the user's hands. When the pillow is engaged to the user the position of the device placed in the mount may be adjusted. The user will be able to view the device at a preferred position while the user is sitting, standing, reclining, or lying on their back.

### CROSS-REFERENCE TO RELATED APPLICATION(S)

The present application claims priority to U.S. Provisional Patent Application No. 62/195,265 filed on Jul. 21, 2015, entitled “HANDS-FREE HOLDER FOR ELECTRONIC DEVICES”, the entire disclosure of which is incorporated by reference herein.

### BACKGROUND OF THE INVENTION

1. Field of Invention

This invention relates to a holder for viewing electronic devices that is hands-free.

2. Description of Related Art

Since the advent of portable handheld electronic devices, there has been a need for a support to avoid having to hold the device up for prolonged periods of time. This may be useful for prolonged interactions with the device, especially if the user is merely viewing content. For example, if a user wishes to view an entire, full-length film on their device they would have to hold the device for the entire duration of the movie if they wish to achieve a proper angle. In many instances, a support like a tabletop, desk, or shelf may not be available. If seated in a chair the user might find that their neck will suffer from strain if they have their device placed on their lap. If they choose to hold the device out in front of them, eventually their arms will begin to tire. If the user chooses to lie down on their back, or recline in a chair while watching video content or interacting with the device the user will have to suspend the device in the air during the duration of the interaction. The user will quickly find that their arms will tire, even if their device is considered lightweight.

The user might also find a need to view their device while performing another action. If there is no support surface readily available, then it will require at least one hand to hold the device. Having one hand holding the device will greatly limit the scope of the actions they might be able to perform. The arm and hand holding the device may also become considerably tired after the passing of a few minutes.

Therefore, there is a need for a support that holds an electronic device in a hands-free way in front of a user, so that the user does not become tired from holding the device during periods of prolonged content consumption.

Furthermore, what might be desired in the art is a support that holds and electronic device in a hands-free way so the user may view the device in a multitude of settings. Such settings may include when lying down, on an airplane, on a recliner chair, while seated as a passenger in a car, or while seated on a park bench for example.

### SUMMARY OF THE INVENTION

The objective of the present invention is to create a hands-free device holder in which the user may view a tablet, cellphone, or other screen device without having to support the device with their hand and arms. The present invention should allow a user to view the device hands free while sitting, standing, or lying on their back.

The objective is achieved according to the invention in that a pillow is adapted to engage the user's body. An arm connected to one end of the pillow an arm will extend out in front of the user's body. A device mount will be placed on the end of the arm opposite of the pillow to allow the user to removably attach their device and view it hands free. The device mount will have two adjustable t-shaped arms and be similar to what is known in the art.

The arm extending from the pillow can be comprised of rigid telescoping segments to allow the user to adjust the distance between them and their mounted device. The arm may also be comprised of a plurality of joints giving the arm semi-rigid articulation so the user can adjust the position of the device relative to their body, but the arm will keep the device's position when left untouched.

The pillow used in the invention will comprise a semi-flexible frame. The frame will be enveloped by stuffing to provide comfort for the user. The stuffing and frame will be enclosed in a removable cover. A strap will keep the pillow engaged with the user's body, and the strap will keep the ends of the pillow from separating.

In another embodiment of the invention, two arms will be connected to the pillow, one from each end. The arms may be comprised rigid and comprised of telescoping segments, or flexible and comprised of a plurality of joints. The arms may be removably attached and interchangeable to allow a variety of configurations.

In the two arm embodiment, the arms may terminate at a single, adjustably connected mount. The arms could also each terminate in a separate mount, allowing the user to interact with two removably connected devices. The arms may also terminate at an adjustable rigid support that the device mount will attach to.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 shows a perspective zipper view of the hands-free holder, according to an embodiment of the present invention.

FIG. 2 shows a perspective zipper view of the hands-free holder, according to an embodiment of the present invention.

FIG. 3 shows a perspective zipper view of the hands-free holder, according to an embodiment of the present invention.

### DETAILED DESCRIPTION OF PREFERRED EMBODIMENTS

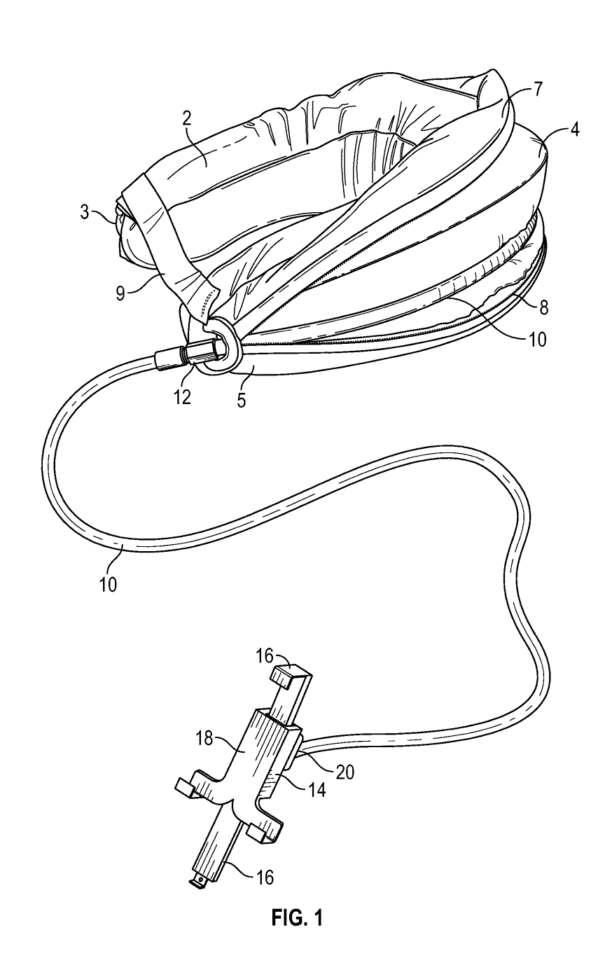

Preferred embodiments of the present invention and their advantages may be understood by referring to FIG. 1 wherein like reference numerals refer to like elements.

FIG. 1 shows the hands-free holder, having a C-shaped pillow 2 adapted to engage a user's neck, or in some cases another body part, wherein the pillow 2 has a first end 3 and a second end 5, is filled with stuffing 4 such as foam or another soft material suitable for a pillow, and in an embodiment, has a removable cover 7 for washing, which is preferably washing machine safe, that encloses the stuffing 4 using a fastener 8 such as a zipper or buttons. In an embodiment, the pillow cover 7 has a retaining strap 9 to keep the first and second ends from separating. The retaining strap 9 may use a Velcro system or a buckle system. The pillow 2 has a semi-rigid articulated arm 10 therein, that extends from the first end 3, within the pillow 2 and following the C-shape, to protrude from the second end 5 of the pillow. In an embodiment, the arm 10 extends through a slot within the foam interior, such that the arm 10 is covered by a portion of the pillow 2 to be soft to the user's touch. In another embodiment, the arm is fused to, or molded within, the foam. In another embodiment, the arm may be external to the pillow, attached by clamps or other attachment means.

The arm 10 has a plurality of joints such that it has flexibility when motivated by the user, but holds its position relative to the pillow when bent in spite of the weight of an electronic device (not shown) and mount 14. In one embodiment, the arm 10 is continuously jointed to permit a variety of positions in front or above the user, such as a gooseneck or stand tube that bends smoothly and holds the bent form. Another beneficial material may be loc-line. The joints are such that they rigidly maintain their position until moved by the user. In an embodiment, the arm 10 is removably connected by a connector 12, such as a threaded joint, for example, or a button-release or twist-lock connector, at the second end 5 of the pillow, such arm 10 may be removed and the pillow used alone. The arm 10 may be longer or shorter depending on the viewing range desired.

The one arm embodiment may be desirable for lighter devices. A one arm embodiment should be considerably lighter than a multi-arm embodiment. It is also ideal for a second person viewing the device, as it is less likely that the view of the second onlooker is going to be obstructed in a single arm embodiment.

The arm 10 extends out from the second end 5 of the pillow and terminates in an adjustable mount 14. The mount 14 is adjustable for size to retain a variety of electronic devices by clamping the device (not shown). The mount 14 has two or more arms 16 to engage the edges of the device (not shown) and retain it. In an embodiment, the mount has an inverted “T” shape with two arms or a ledge for holding the edge of the electronic device, and a single upper rod for stabilizing the electronic device. An adjustment mechanism 18, either by spring biasing of the arms, or a rotating cable mechanism known in the art, permits the mount 14 to accommodate smaller and larger devices. The mount 14 is attached to the arm 10 by a swivel joint 20, using a ball and socket in an embodiment, to permit angular adjustment.

The angular position of the mount 14 is maintained by the swivel joint 20 in the absence of force to change the angle. The swivel joint 20 may have a lock (not shown), such as a bolt lock wherein a bolt applies pressure to the joint to prevent movement in the joint while the bolt lock is engaged. The bolt lock is user adjustable with a rotatable knob to tighten or loosen the bolt.

While seated, the user may use the C-shaped pillow for sleeping as, when mounted around the neck it supports the head. In use, the user places the pillow 2 around the neck, and clamps the electronic device (not shown) in the mount 14. Then he or she adjusts the arm 10 such that the electronic device is located in a convenient position for viewing. If the user should fall asleep, the device is comfortably maintained at a safe distance to avoid harming viewer or device.

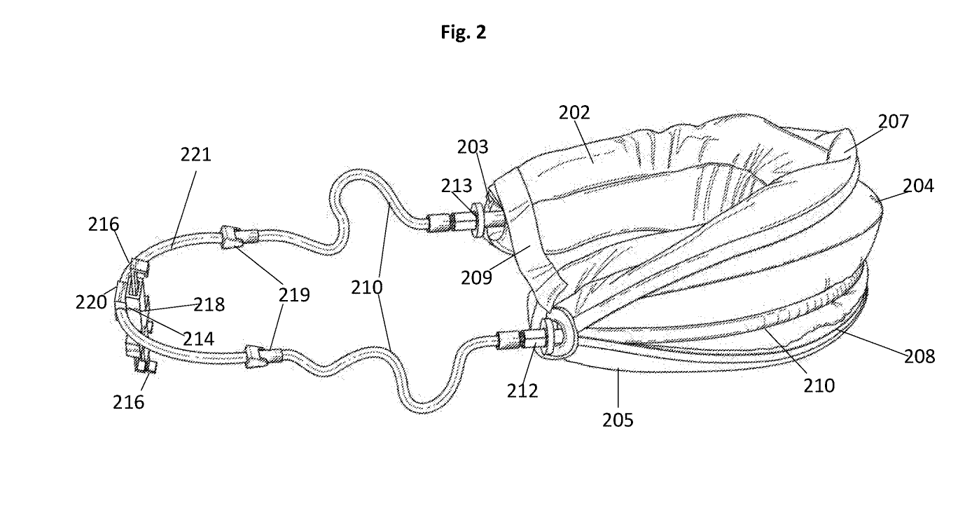

Preferred embodiments of the present invention and their advantages may be understood by referring to FIG. 2 wherein like reference numerals refer to like elements.

FIG. 2 shows the hands-free holder, having a C-shaped pillow 202 adapted to engage a user's neck, or in some cases another body part, wherein the pillow 202 has a first end 203 and a second end 205, is filled with stuffing 204 such as foam or another soft material, and in an embodiment, has a removable cover 207 for washing that encloses the stuffing 204 using a fastener 208 such as a zipper or buttons. In an embodiment, the pillow cover 207 has a retaining strap 209, which may be engaged with Velcro or one or more buckles, to keep the first and second ends from separating. The pillow 202 has two semi-rigid articulated arms 210 therein, that extend from the ends 203,205 and are contained within the pillow 202 and following the C-shape. In an embodiment, the arms 210 extend through a slot within the foam interior, such that the arms 210 are covered by a portion of the pillow 202 to be soft to the user's touch. In another embodiment, the arms are fused to, or molded within, the foam. In another embodiment, the arms may be external to the pillow, attached by clamps or other attachment means.

The arms 210 may have a plurality of joints such that it has flexibility when motivated by the user, but holds its position relative to the pillow when bent in spite of the weight of an electronic device (not shown) and mount 214. In one embodiment, the arms 210 are continuously jointed to permit a variety of positions in front or above the user, such as a gooseneck or stand tube that bends smoothly and holds the bent form. Another beneficial material is loc-line. The joints are such that they rigidly maintain their position until moved by the user. In an embodiment, the arms 210 are removably connected by a connector 212 and 213, such as a threaded joint, for example, or a button-release or twist-lock connector, at end 205 and 203 of the pillow, such that arms 210 may be removed and the pillow used alone. The arms 210 may be longer or shorter depending on the viewing range desired.

The two arm embodiment may be advantageous for larger devices or extended ranges. The two arm embodiment will be more likely to keep the device at the position desired by the user without unwanted movement, even if the device is a bit heavier than predicted. In the case that the user wants the device a bit further out in front of them, the additional arm will help overcome the additional torque created by the extended range.

The arms 210 extend out from the ends 203,205 of the pillow and terminate in an adjustable mount 214. The mount 214 is adjustable for size to retain a variety of electronic devices by clamping the device (not shown). The mount 214 has two or more arms 216 to engage the edges of the device (not shown) and retain it. In an embodiment, the mount has an inverted “T” shape with two arms or a ledge for holding the edge of the electronic device, and a single upper rod for stabilizing the electronic device. An adjustment mechanism 218, either by spring biasing of the arms, or a rotating cable mechanism known in the art, permits the mount 214 to accommodate smaller and larger devices. The mount 214 is attached to the arm 210 by a swivel joint 220, using a ball and socket in an embodiment, to permit angular adjustment.

The angular position of the mount 214 is maintained by the swivel joint 220 in the absence of force to change the angle. The swivel joint 220 may have a lock (not shown), such as a bolt lock wherein a bolt applies pressure to the joint to prevent movement in the joint while the bolt lock is engaged. The bolt lock is user adjustable with a rotatable knob to tighten or loosen the bolt.

In an embodiment, fasteners 219 allow for a rotational movement allow further adjustment of the device angle. This allows the user to make quick adjustments to achieve the proper view of the device. In another embodiment, the fasteners 219 are locks for swivel joints. This allows a ball swivel action to provide further adjustment of the device to allow the user to achieve a proper view of the device. In another embodiment, the fasteners 219 are telescopic locks the hollow ridged tube 221 with an inner diameter large enough to allow the arms 210 to move telescopically inside. When the fasteners 219 are engage, pressure applied to the arms 210 locks them into place preventing the telescopic movement.

While seated, the user may use the C-shaped pillow for sleeping as, when mounted around the neck it supports the head. In use, the user places the pillow 202 around the neck, and clamps the electronic device (not shown) in the mount 214. Then he or she adjusts the arm 210 such that the electronic device is located in a convenient position for viewing. If the user should fall asleep, the device is comfortably maintained at a safe distance to avoid harming viewer or device.

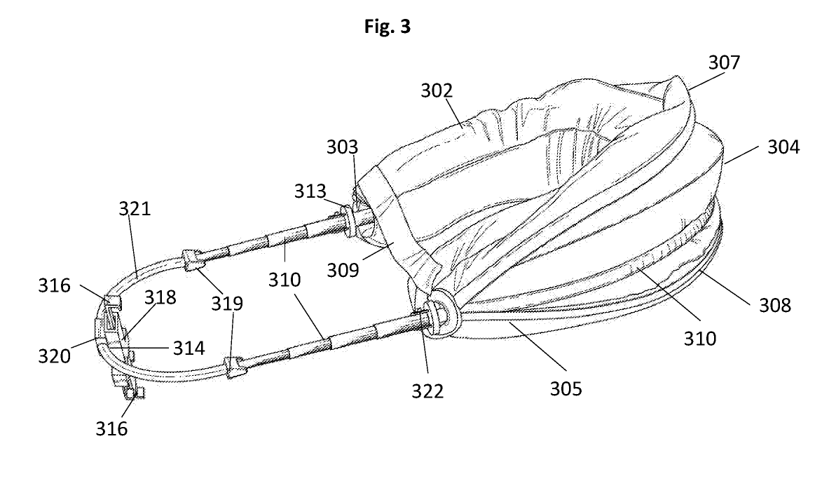

Preferred embodiments of the present invention and their advantages may be understood by referring to FIG. 3 wherein like reference numerals refer to like elements.

FIG. 3 shows the hands-free holder, having a C-shaped pillow 302 adapted to engage a user's neck, or in some cases another body part, wherein the pillow 302 has a first end 303 and a second end 305, is filled with stuffing 304 such as foam or another soft material, and in an embodiment, has a removable cover 307 for washing that encloses the stuffing 304 using a fastener 308 such as a zipper or buttons. In an embodiment, the pillow cover 307 has a retaining strap 309 to keep the first and second ends from separating. The pillow 302 has one or more rigid articulated arms 310 therein, that extend from the first end 303, and may extend from the second end 305, attaching to a connector 313 and held in place with a locking swivel joint 322. In an embodiment, the swivel joint 322 will allow the user to adjust the angle of the arms 310 to position the device in a preferred fashion. In an embodiment, the arms 310 may extend through a slot within the foam interior, such that the arms 310 are covered by a portion of the pillow 302 to be soft to the user's touch. In another embodiment, the arms are fused to, or molded within, the foam. The arms may be external to the pillow, attached by clamps or other attachment means.

In an embodiment, the arms 310 are telescoping allowing the user to adjust the distance between the device and their face. In an embodiment, the telescoping segments may feature a twist lock system in which the user twists a segment in a specified direction to lock it in place. In another embodiment, the telescoping segments may feature a pull/push lock system in which the user pulls out or pushes the telescoping features into a snug fit which keeps them locked in place. The embodiment including telescoping arms 310 will provide the stability for the device which is removably fixed into the mount. The telescoping arms may provide more rigidity than the flexible arms described in the other embodiments. The extra rigidity may allow for proper support of heavier devices

In an embodiment, the arms 310 extend out from the ends 303,305 of the pillow and terminate at swivel joints 319. The swivel joints allow for adjustment between the telescoping arms 310 and the rigid c-shape support 321 that holds the mount 314. The mount 314 is adjustable for size to retain a variety of electronic devices by clamping the device (not shown). The mount 314 has two or more arms 316 to engage the edges of the device (not shown) and retain it. In an embodiment, the mount has an inverted “T” shape with two arms or a ledge for holding the edge of the electronic device, and a single upper rod for stabilizing the electronic device. An adjustment mechanism 318, either by spring biasing of the arms, or a rotating cable mechanism known in the art, permits the mount 314 to accommodate smaller and larger devices.

The angular position of the mount 314 is maintained by the swivel joint 320 in the absence of force to change the angle. The swivel joint 320 may have a lock (not shown), such as a bolt lock wherein a bolt applies pressure to the joint to prevent movement in the joint while the bolt lock is engaged. The bolt lock is user adjustable with a rotatable knob to tighten or loosen the bolt.

In an embodiment, the arms 310 may each be adjustably connected to a separate device mount 314. This embodiment will enable the user to interact with two devices, each being supported by one of the two arms 310 that are extending from the pillow 302. In one embodiment, both arms may contain a plurality of joints to provide semi-rigid articulation. In another embodiment, both arms may be comprised of rigid telescopic segments with friction locking or twist locking capabilities. In another embodiment, the user may be able to have one arm attached with semi-rigid articulation and another attached with the rigid telescoping segments. In this embodiment, the user will have the option to connect, disconnect, and arrange the arms on to the ends of the pillow as he or she pleases.

While seated, the user may use the C-shaped pillow for sleeping as, when mounted around the neck it supports the head. In use, the user places the pillow 302 around the neck, and clamps the electronic device (not shown) in the mount 314. Then he or she adjusts the arm 310 such that the electronic device is located in a convenient position for viewing. If the user should fall asleep, the device is comfortably maintained at a safe distance to avoid harming viewer or device.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A hands-free holder comprising:
a. a pillow adapted to engage the user's body comprising of two ends;
b. an arm connected at one end of the pillow and extending out in front of a user's body; and
c. a mount for a portable screen device, wherein the mount is adjustably connected to the end of the arm.

2. The hands-free holder of claim 1 wherein the mount comprises of two or more adjustable T-shaped arms to allow devices of various shapes to be removably attached to the device mount.

3. The hands-free holder wherein the arm is semi-rigidly articulated containing continuous pressure jointing such that it has flexibility when motivated by the user but holds its position relative to the c-shaped harness in spite of the weight of a portable interactive screen device.

4. The hands-free holder of claim 1 wherein the arm is comprised of locking telescopic segments which allow the user to vary the lengths of the arms.

5. The hands-free holder of claim 1, wherein the pillow is further comprised of:
a. an internal flexible frame;
b. a soft stuffing which envelopes the frame;
c. a removable cover which encases the soft stuffing; and
d. a retainer strap at the ends of the cover to keep the pillow ends from separating wherein the user may adapt the pillow to engage the body and limit movement of the pillow

6. The hands-free holder of claim 5 wherein the internal flexible frame is rigidly articulated containing continuous pressure jointing such that it has flexibility when motivated by an outside force but holds its position otherwise

7. The hands-free holder of claim 5 wherein said pillow may have a c-shaped structure

8. A hands-free holder comprising:
a. a pillow adapted to engage the user's body comprising of two ends;
b. two arms connected at the ends of the pillow and extending out in front of a user's body; and
c. a mount for a portable screen device, wherein the mount is adjustably connected to the ends of the arms.

9. The hands-free holder of claim 8 wherein the mount comprises of two or more adjustable T-shaped arms to allow devices of various shapes to be removably attached to the device mount.

10. The hands-free holder of claim 8 wherein the arms are semi-rigidly articulated containing continuous pressure jointing such that they have flexibility when motivated by the user but hold their position relative to the c-shaped harness in spite of the weight of a portable interactive screen device.

11. The hands-free holder of claim 8 wherein the arms are comprised of locking telescopic segments which allow the user to vary the lengths of the arms.

12. The hands-free holder of claim 8 wherein the arms may terminate at an adjustable c-shape support.

13. The hands-free holder of claim 12 wherein the adjustable c-shape support may contain an adjustable device mount.

14. The hands-free holder of claim 8 wherein each arm may adjustably connect to a separate device mount.

15. The hands-free holder of claim 8, wherein the adapted pillow is comprised of:
a. an internal flexible frame;
b. a soft stuffing which envelopes the frame;
c. a removable cover which encases the soft stuffing; and
d. a retainer strap at the ends of the cover to keep the pillow ends from separating and to engage the body and limit the movement of the pillow.

16. The hands-free holder of claim 15 wherein the internal flexible frame is rigidly articulated containing continuous pressure jointing such that it has flexibility when motivated by an outside force but holds its position otherwise.

17. The hands-free holder of claim 15 wherein said pillow may have a c-shaped structure.
